(19) United States
(12) Patent Application Publication
(10) Pub. No.: US 2026/0193137 A1
(43) Pub. Date: Jul. 9, 2026

(54) DIELECTRIC COMPOSITION WITH HIGH-TEMPERATURE STABILITY

(71) Applicant: AMOTECH CO., LTD., Incheon (KR)

(72) Inventors: Heerim KIM, Incheon (KR); Soomin OH, Incheon (KR); Junsuh YU, Incheon (KR); Tonggi KIM, Incheon (KR); Yeonsoo CHUNG, Incheon (KR)

(73) Assignee: AMOTECH CO., LTD., Incheon (KR)

(21) Appl. No.: 19/132,091

(22) PCT Filed: Nov. 21, 2023
(86) PCT No.: PCT/KR2023/018727

§ 371 Date: May 22, 2025

(30) Foreign Application Priority Data
Nov. 24, 2022 (KR) 10-2022-0158912

(51) Int. Cl. C04B 35/468; C04B 35/64; H01G 4/12; H01G 4/30

(52) U.S. Cl. CPC C04B 35/4682; C04B 35/64; H01G 4/1227; C04B 2235/3224; C04B 2235/3236; C04B 2235/3239; C04B 2235/3241; C04B 2235/3267; C04B 2235/3418; C04B 2235/442; C04B 2235/656; C04B 2235/9607; H01G 4/30

(57) ABSTRACT

Disclosed is a dielectric composition including a barium titanate-based base material major component and a minor component. The dielectric composition includes any one of oxides and carbonates of at least Yb element among oxides and carbonates of Mg, Si, V, Mn and Cr, Ba and Yb elements. A dielectric material formed by sintering the dielectric composition satisfies the X8R properties specified by the EIA specification.

### TECHNICAL FIELD

The present disclosure relates to a dielectric composition with high-temperature stability, and in particular, to a dielectric composition that satisfies the X8R properties.

### BACKGROUND ART

Multilayer ceramic chip capacitors have high capacity and high reliability, but have a relatively small size, and therefore, are widely used in the fields requiring precision and stability such as automobiles and motors.

There are requirements for stacked ceramic capacitors on various factors such as capacity, temperature stability and voltage stability. Particularly, stacked ceramic capacitors for electric fields used in automobiles operate under a high temperature, and therefore, the capacity (capacitance) should not change even at a high temperature. In this regard, the Electronic Industries Association (EIA) provides that a stacked ceramic capacitor satisfies the X8R properties when a change in the capacitance at temperatures of −55° C. to 150° C. is around 15% with respect to reference capacitance at 25° C.

### SUMMARY OF INVENTION

### Technical Problem

The present disclosure is directed to providing a dielectric composition that satisfies the X8R specification.

### Solution to Problem

A dielectric composition according to embodiments of the present disclosure includes a barium titanate-based base material major component and a minor component, wherein the minor component includes at least one of a first minor component including at least one of oxides and carbonates of fixed-valance acceptor element including Mg; a second minor component including at least one selected from the group consisting of oxides, carbonates and glass of Si element; a third minor component including at least one of oxides and carbonates of V element; a fourth minor component including at least one selected from the group consisting of oxides and carbonates of variable-valence acceptor element including at least one of Mn, Cr, Fe, Ni, Co, Cu and Zn; a fifth minor component including at least one selected from the group consisting of oxides and carbonates of Ba element; and a sixth minor component including at least one selected from the group consisting of oxides and carbonates of Yb element, the at least one minor component includes the sixth minor component, and a content of the Yb element included in the sixth minor component is from 0.4 parts by mole to 14 parts by mole with respect to 100 parts by mole of the base material major component.

### Advantageous Effects of Invention

A dielectric composition of the present disclosure satisfies the X8R properties of the EIA specification.

### BRIEF DESCRIPTION OF DRAWINGS

FIG. 1 illustrates a stacked ceramic capacitor according to an embodiment of the present disclosure.

FIG. 2 illustrates a stacked ceramic capacitor according to an embodiment of the present disclosure.

### DESCRIPTION OF EMBODIMENTS

Hereinafter, the most preferred embodiments of the present disclosure will be described with reference to accompanying drawings in order to describe technical ideas of the present disclosure in detail to a degree that those skilled in the art may readily implement the technical ideas. First, it needs to be noted that, when adding reference numerals to constituents of each drawing, the same constituents are given the same numerals as possible even when they are shown in different drawings. In addition, when it is considered that, in describing the present disclosure, specific descriptions of known constitutions or functions related thereto may obscure the gist of the present disclosure, the detailed descriptions are not included.

The present disclosure relates to a dielectric composition, and an electronic component including the dielectric composition may include a capacitor, an inductor, a piezoelectric element, a varistor or a thermistor. Hereinafter, a stacked ceramic capacitor will be described as an example of the dielectric composition and the electronic component.

### Stacked Ceramic Capacitor

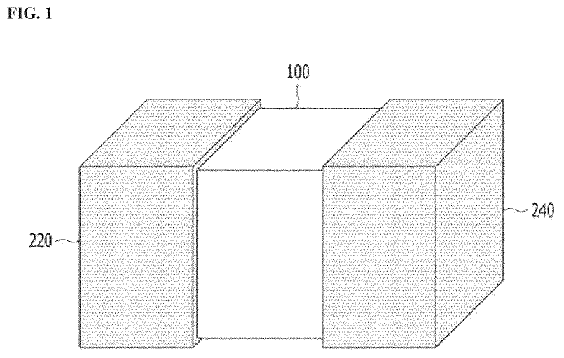

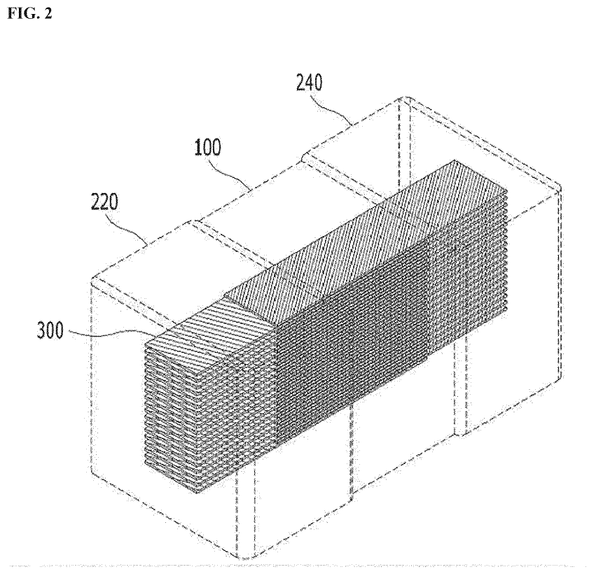

FIGS. 1 and 2 each illustrate a stacked ceramic capacitor according to an embodiment of the present disclosure. Referring to FIG. 1, the stacked ceramic capacitor according to an embodiment of the present disclosure is formed to include a dielectric 100, a first external electrode 220 and a second external electrode 240.

The dielectric 100 is formed as a rectangular parallelepiped having an upper surface, a lower surface, a first side surface, a second side surface opposite to the first side surface, a third side surface, and a fourth side surface opposite to the third side surface. As an example, the first side surface is the left side in the drawing, the second side surface is the right side in the drawing, the third side surface is the front surface in the drawing, and the fourth side surface is the rear surface in the drawing.

The dielectric 100 may include a plurality of dielectric sheets. The plurality of dielectric sheets may be stacked. Each of the dielectric sheets includes a dielectric composition, and may be formed by sintering the dielectric composition.

The first external electrode 220 is an electrode disposed on the first side surface of the dielectric 100. The first external electrode 220 and the second external electrode 240 may be formed to extend from the first side surface of the dielectric 100 to the upper surface, the lower surface, the third side surface and the fourth side surface of the dielectric 100. The second external electrode 240 is an electrode disposed on the second side surface of the dielectric 100. The first external electrode 220 and the second external electrode 240 may be formed to extend from the second side surface of the dielectric 100 to the upper surface, the lower surface, the third side surface and the fourth side surface of the dielectric 100. Herein, the first external electrode 220 and the second external electrode 240 may be formed to face each other while being separated at a predetermined interval from the upper surface, the lower surface, the third side surface and the fourth side surface of the dielectric 100.

Referring to FIG. 2, the stacked ceramic capacitor according to an embodiment of the present disclosure may further include a plurality of electrode units 300. Herein, the plurality of electrode units 300 may be stacked to form a laminate, and this laminate is disposed inside the dielectric 100.

The plurality of electrode units 300 are stacked in a vertical direction in the drawing to be disposed inside the dielectric 100. Each of the electrode units 300 includes a first electrode set 320 and a second electrode set 340, and the first electrode set 320 and the second electrode set 340 are alternately stacked to be formed.

The first electrode set 320 is formed as a plate-shaped conductor formed in a rectangular shape. The first electrode set 320 is disposed to lean toward the first side surface of the dielectric 100 inside the dielectric 100. A first end of the first electrode set 320 is connected to the first external electrode 220 on the first side surface of the dielectric 100.

The second electrode set 340 is formed as a plate-shaped conductor formed in a rectangular shape. The second electrode set 340 is disposed to lean toward the second side surface of the dielectric 100 inside the dielectric 100. A first end of the second electrode set 340 is connected to the second external electrode 240 on the second side surface of the dielectric 100.

The first electrode set 320 and the second electrode set 340 are each distributed and disposed on two adjacent dielectric sheets among the dielectric sheets included in the dielectric 100. The first electrode set 320 and the second electrode set 340 may be partially overlapped with the dielectric sheet 110 in between.

### Dielectric Composition and Method for Preparing the Same

Hereinafter, a dielectric composition according to embodiments of the present disclosure and a method for preparing the same will be described in detail. The dielectric composition may form the dielectric 100 described above. However, in order to avoid redundant description, description overlapping the description provided above will not be included.

The dielectric composition according to embodiments of the present disclosure may include a base material major component including rare-earth elements. The base material major component is a barium titanate-based compound including Ba and Ti, and may preferably be BaTiO₃. In addition, the dielectric composition according to embodiments of the present disclosure further includes a minor component, and the minor component may include a first minor component to a sixth minor component.

The dielectric composition according to embodiments of the present disclosure satisfies the X8R (−55° C. to 150° C.) properties specified in the EIA (Electronic Industries Association) specification, and therefore, may achieve a dielectric composition having excellent reliability and a stacked ceramic capacitor including the same.

The dielectric composition according to embodiments of the present disclosure may include the minor components of Table 1 per 100 mol of the base material BaTiO₃.

TABLE 1

| | Second | | | | | |
|---|---|---|---|---|---|---|
| First Minor | Minor | Third Minor | Fourth Minor | | Fifth Minor | Sixth Minor |
| Component | Component | Component | Component | | Component | Component |
| MgCO₃ | SiO₂ | V₂O₅ | Cr₂O₃ | MnO₂ | BaCO₃ | Yb₂O₃ |
| 0-2.0 | 0.5-3.5 | 0-3.5 | 0.05- | 0.1-0.4 | 0.05-3.0 | 0.2-7.0 |
| | | | 2.0 | | | |

Hereinafter, each component of the dielectric composition according to embodiments of the present disclosure will be described more specifically.

### Base Material Major Component

The dielectric composition according to embodiments of the present disclosure may include a base material major component including Ba and Ti. According to embodiments, the base material major component is BaTiO₃.

The base material major component may be included in the dielectric composition in a powder form. An average particle diameter of the base material major component powder is not particularly limited, but may be 1000 nm or less. Preferably, an average particle diameter of the base material major component powder may be from 200 nm to 350 nm, and more preferably 250 nm.

### First Minor Component

The dielectric composition according to embodiments of the present disclosure may include at least one of oxides and carbonates of fixed-valence acceptor element including Mg as the first minor component.

The first minor component may be included in an amount of 2.0 parts by mole or less with respect to 100 parts by mole of the base material major component. The content of the first minor component may be based on the content of the Mg element included in the first minor component regardless of the form of addition such as an oxide or a carbonate. For example, the content of the Mg element included in the first minor component may be 2.0 parts by mole or less with respect to 100 parts by mole of the base material major component.

The content of the first minor component being greater than 2.0 parts by mole with respect to 100 parts by mole of the dielectric base material major component is not preferred since there may be a problem in that the permittivity and the high temperature withstand voltage properties are reduced.

### Second Minor Component

The dielectric composition according to embodiments of the present disclosure may include at least one selected from the group consisting of oxides of Si element, carbonates of Si element and glass including Si element as the second minor component.

The second minor component may be included in an amount of 0.5 parts by mole to 3.5 parts by mole with respect to 100 parts by mole of the base material major component. The content of the second minor component may be based on the content of the Si element included in the second minor component regardless of the form of addition such as glass, an oxide or a carbonate.

The content of the second minor component being less than 0.5 parts by mole with respect to 100 parts by mole of the dielectric base material major component is not preferred since the permittivity and the high temperature withstand voltage may be reduced, and the content being greater than 3.5 parts by mole is not preferred as well since there may be a problem of reducing sinterability and density, forming a secondary phase, and the like.

### Third Minor Component

The dielectric composition according to embodiments of the present disclosure may include at least one of oxides including V and carbonates thereof as the third minor component.

The third minor component may be included in an amount of 0 part by mole to 7 parts by mole with respect to 100 parts by mole of the base material major component. The content of the third minor component may be based on the content of the V element included in the third minor component regardless of the form of addition such as an oxide or a carbonate. For example, the content of the V element included in the third minor component may be 7 parts by mole or less with respect to 100 parts by mole of the base material major component.

The third minor component performs a role of stabilizing a change in the capacity at a high temperature, and when the content of the third minor component is greater than 7 parts by mole with respect to 100 parts by mole of the dielectric base material major component, the high temperature withstand voltage may be reduced.

### Fourth Minor Component

The dielectric composition according to embodiments of the present disclosure may include at least one of at least one element selected from the group consisting of Mn, Cr, Fe, Ni, Co, Cu and Zn, oxides thereof and carbonates thereof as the fourth minor component.

The fourth minor component may be included in an amount of 0.2 parts by mole to 4.4 parts by mole with respect to 100 parts by mole of the base material major component. The content of the fourth minor component may be based on the content of the at least one of Mn, Cr, Fe, Ni, Co, Cu and Zn elements included in the fourth minor component regardless of the form of addition such as an oxide or a carbonate. For example, the total content of the at least one variable-valence acceptor element among Mn, Cr, Fe, Ni, Co, Cu and Zn included in the fourth minor component may be from 0.2 parts by mole to 4.4 parts by mole based on 100 parts by mole of the base material major component.

The fourth minor component performs a role of increasing the IR value, and when the content of the fourth minor component is less than 0.2 parts by mole, the IR properties may decline, reducing reliability. In addition, when the content of the fourth minor component is greater than 4.4 parts by mole, the high temperature accelerated lifetime may be reduced.

### Fifth Minor Component

The dielectric composition according to embodiments of the present disclosure may include at least one selected from the group consisting of oxides and carbonates of Ba element as the fifth minor component.

The fifth minor component may be included in an amount of 0.05 parts by mole to 3.0 parts by mole with respect to 100 parts by mole of the base material major component. The content of the fifth minor component may be based on the content of the Ba element included in the fifth minor component regardless of the form of addition such as an oxide or a carbonate. For example, the total content of the Ba element included in the fifth minor component may be from 0.05 parts by mole to 3.0 parts by mole with respect to 100 parts by mole of the base material major component.

When the fifth minor component is included in an amount of 0.05 parts by mole to 3.0 parts by mole with respect to 100 parts by mole of the base material major component, the high temperature withstand voltage properties may be improved.

### Sixth Minor Component

The dielectric composition according to embodiments of the present disclosure may include at least one selected from the group consisting of oxides and carbonates of Yb element as the sixth minor component. Alternatively, the sixth minor component may also include at least one selected from the group consisting of oxides and carbonates of at least one of Y, Dy, Ho, Sm, Gd, Er, La, Ce and Nd elements, which are other rare-earth elements, instead of the Yb element.

The sixth minor component may be included in an amount of 0.4 parts by mole to 14 parts by mole with respect to 100 parts by mole of the base material major component. The content of the sixth minor component may be based on the content of the element included in the sixth minor component regardless of the form of addition such as an oxide or a carbonate. For example, the total content of the element included in the sixth minor component may be from 0.4 parts by mole to 14 parts by mole with respect to 100 parts by mole of the base material major component.

The sixth minor component performs a role of preventing a decrease in the reliability of the stacked ceramic capacitor formed with the dielectric composition according to embodiments of the present disclosure.

When the content of the sixth minor component is less than 0.4 parts by mole with respect to 100 parts by mole of the base material major component, the effect of improving high temperature TCC (temperature coefficient of capacitance) may not be significant, and when the content of the sixth minor component is greater than 14 parts by mole with respect to 100 parts by mole of the base material major component, the high temperature withstand voltage properties may decline.

### Experimental Example

A BaTiO₃ mixed solid solution powder, which is a base material powder including a major component, was prepared using a solid phase method as follows.

Starting raw materials are BaCO₃ and TiO₂. These starting raw material powders were mixed using a ball mill and calcined in a range of 900° C. to 1000° C. to prepare a major component base material powder. After adding a minor component additive powder to the major component base material powder in the composition ratio specified in Table 2, the raw material powder including the major component and the minor component was ball milled for a predetermined time (for example, 20 hours) by using a zirconia ball as a mixing/dispersing medium and mixing ethanol/toluene, a dispersant and a binder.

The prepared slurry was prepared into a molded sheet having a thickness of 10 μm using a doctor blade-type coater. On the molded sheet, a Ni internal electrode was printed. Upper and lower covers were prepared by stacking a sheet for covering to 25 layers, and 21 layers of the printed active sheets were stacked while pressurizing to prepare a press bar. The press bar was cut into chips having a size of 3225 (length×width×thickness of 3.2 mm×2.5 mm×2.5 mm) using a cutter.

The prepared chip was plasticized, then baked for 1 hour or longer at a temperature of 1250° C. to 1350° C. under a reduced atmosphere (0.1% H₂/99.9% N₂, H₂O/H₂/N₂ atmosphere), and then heat treated by conducting reoxidation for 2 hours or longer at 1000° C. under a nitrogen (N₂) atmosphere.

The baked chip underwent termination process and electrode baking using a copper paste to complete an external electrode.

For the stacked ceramic capacitor specimen completed as above, capacity (permittivity), temperature-dependent change in capacitance (TCC), high temperature withstand voltage and the like were measured and evaluated. In addition, room temperature insulation resistance, high temperature accelerated lifetime, loss factor and the like were evaluated in addition thereto, which, however, are not described.

As for room temperature capacitance, capacity was measured under a condition of 1 kHz and AC 0.2 V/μm using an LCR-meter. From the capacitance, the dielectric thickness of the stacked ceramic capacitor (MLCC) chip, the internal electrode area and the number of stackings, the permittivity of the stacked ceramic capacitor (MLCC) chip was calculated.

The temperature-dependent change in capacitance was measured in a temperature range of −55° C. to 150° C. In the corresponding temperature range, the change in capacity was measured under a condition of 1 kHz and 1 Vrms using an LCR-meter. Herein, the rate of change (%) in capacitance at each temperature was measured with respect to the capacitance at 25° C. In the present specification, the change in capacitance at 150° C. is described.

As for the high temperature withstand voltage, the voltage at which IR withstood 100 GΩ or greater was measured when applying a voltage step of DC 5 V/μm for 10 minutes at 150° C. and continuously increasing this voltage step. When the high temperature withstand voltage was 50 V/μm or greater, it was determined as satisfactory, and when the high temperature withstand voltage was less than 40 V/μm, it was determined as poor.

The following Table 2 shows the composition of the experimental example, and Table 3 shows properties of the stacked ceramic capacitor chip corresponding to the composition specified in Table 2.

TABLE 2

| | Number of Moles of Minor Component per 100 Mol of Base Material Major | | | | | | |
|---|---|---|---|---|---|---|---|
| | Component | | | | | | |
| | | Second | Third | | | | Sixth |
| | First Minor | Minor | Minor | Fourth Minor | | Fifth Minor | Minor |
| | Component | Component | Component | Component | | Component | Component |
| Sample | MgCO₃ | SiO₂ | V₂O₅ | Cr₂O₃ | MnO₂ | BaCO₃ | Yb₂O₃ |
| 1 | 0.9 | 2.7 | 0 | 0.13 | 0.35 | 2 | 4.2 |
| 2 | 0.9 | 2.7 | 0.25 | 0.13 | 0.35 | 2 | 4.2 |
| 3 | 0.9 | 2.7 | 2 | 0.13 | 0.35 | 2 | 4.2 |
| 4 | 0.9 | 2.7 | 3.5 | 0.13 | 0.35 | 2 | 4.2 |
| 5 | 0.9 | 2.7 | 4 | 0.13 | 0.35 | 2 | 4.2 |

TABLE 3

| | | High | High Temperature | |
|---|---|---|---|---|
| | | Temperature | (150° C.) | Determi- |
| | | TCC | Withstand Voltage | nation of |
| Sample | Permittivity | (150° C.) | (V/μm) | Properties |
| 1 | 1421 | −15.8 | Satisfactory | X |
| 2 | 1381 | −13.9 | Satisfactory | ◯ |
| 3 | 1356 | −13.6 | Satisfactory | ◯ |
| 4 | 1313 | −12.9 | Satisfactory | ◯ |
| 5 | 1178 | −12.1 | Satisfactory | X |

Samples 1 to 5 of Table 2 represent samples in which the content of the third minor component V is changed while the content of the first minor component Mg is fixed at 0.9 mol, the content of the second minor component Si is fixed at 2.7 mol, the total content of the fourth minor component (Cr, Mn) is fixed at 0.61 mol, the content of the fifth minor component Ba is fixed at 2 mol and the content of the sixth minor component Yb is fixed at 8.4 mol, and Samples 1 to 5 of Table 3 represent properties of the samples corresponding to Samples 1 to 5 of Table 2.

When the content of the third minor component V is 0 mol (Sample 1), the high temperature TCC (150° C.) deviates from ±15%, making them vulnerable to a temperature change, and when the content is greater than 7 mol (Sample 5), the permittivity decreases to 1200 or less, causing a problem in reliability. In addition, the RC value decreases as well in this case, causing a problem in reliability. When the content of the third minor component V is in a range of greater than 0 mol (for example, 0.5 mol or greater) and 7 mol or less (Samples 2 to 4), the high temperature TCC is within ±15%, satisfying the X8R specification, and favorable high temperature withstand voltage properties of 50 V/μm or greater may be obtained. Accordingly, it may be said that the appropriate content range of the third minor component V is greater than 0 part by mole and 7 parts by mole or less in element ratio with respect to 100 parts by mole of the base material major component.

TABLE 4

| | Number of Moles of Minor Component per 100 Mol of Base Material | | | | | | |
|---|---|---|---|---|---|---|---|
| | Major Component | | | | | | |
| | | Second | Third | | | | Sixth |
| | First Minor | Minor | Minor | Fourth Minor | | Fifth Minor | Minor |
| | Component | Component | Component | Component | | Component | Component |
| Sample | MgCO₃ | SiO₂ | V₂O₅ | Cr₂O₃ | MnO₂ | BaCO₃ | Yb₂O₃ |
| 6 | 0.9 | 2.7 | 0.25 | 0.13 | 0.35 | 2 | 0 |
| 7 | 0.9 | 2.7 | 0.25 | 0.13 | 0.35 | 2 | 0.2 |
| 8 | 0.9 | 2.7 | 0.25 | 0.13 | 0.35 | 2 | 1 |
| 9 | 0.9 | 2.7 | 0.25 | 0.13 | 0.35 | 2 | 2 |
| 10 | 0.9 | 2.7 | 0.25 | 0.13 | 0.35 | 2 | 3 |
| 11 | 0.9 | 2.7 | 0.25 | 0.13 | 0.35 | 2 | 4.6 |
| 12 | 0.9 | 2.7 | 0.25 | 0.13 | 0.35 | 2 | 5 |
| 13 | 0.9 | 2.7 | 0.25 | 0.13 | 0.35 | 2 | 5.05 |
| 14 | 0.9 | 2.7 | 0.25 | 0.13 | 0.35 | 2 | 7 |
| 15 | 0.9 | 2.7 | 0.25 | 0.13 | 0.35 | 2 | 7.5 |

TABLE 5

| | | High | High Temperature | |
|---|---|---|---|---|
| | | Temperature | (150° C.) | Determi- |
| | | TCC | Withstand Voltage | nation of |
| Sample | Permittivity | (150° C.) | (V/μm) | Properties |
| 6 | 1523 | −18.3 | Satisfactory | X |
| 7 | 1482 | −14.9 | Satisfactory | ◯ |
| 8 | 1417 | −14.6 | Satisfactory | ◯ |
| 9 | 1412 | −14.3 | Satisfactory | ◯ |
| 10 | 1401 | −14.1 | Satisfactory | ◯ |
| 11 | 1379 | −13.6 | Satisfactory | ◯ |
| 12 | 1374 | −13.5 | Satisfactory | ◯ |
| 13 | 1344 | −13.5 | Satisfactory | ◯ |
| 14 | 1308 | −13.1 | Satisfactory | ◯ |
| 15 | 1283 | −13.2 | Poor | X |

Samples 5 to 12 of Table 4 represent samples in which the content of the sixth minor component Yb is changed while the content of the first minor component Mg is fixed at 0.9 mol, the content of the second minor component Si is fixed at 2.7 mol, the content of the third minor component V is fixed at 0.5 mol, the total content of the fourth minor component (Cr, Mn) is fixed at 0.61 mol and the content of the fifth minor component Ba is fixed at 2 mol, and Samples 6 to 15 of Table 5 represent properties of the samples corresponding to Samples 6 to 15 of Table 4.

When the content of the sixth minor component Yb is 0 mol (Sample 6), the high temperature TCC (150° C.) deviates from ±15%, causing a problem of being vulnerable to a temperature change. In addition, when the content of the sixth minor component Yb is greater than 14 mol (Sample 15), the high temperature TCC (150° C.) does not deviate from ±15%, however, there is a problem in that the high temperature withstand voltage properties are poor. When the content of the sixth minor component Yb is in a range of greater than 0 mol (for example, 0.4 mol or greater) and 14 mol or less (Samples 7 to 14), the high temperature TCC is within ±15%, satisfying the X8R specification, and favorable high temperature withstand voltage properties of 50 V/μm or greater may be obtained. Accordingly, it may be said that the appropriate content range of the sixth minor component Yb is greater than 0 part by mole and 14 parts by mole or less in element ratio with respect to 100 parts by mole of the base material major component.

TABLE 6

| | | Number of Moles of Minor Component per 100 Mol of Base Material | | | | | | |
|---|---|---|---|---|---|---|---|---|
| | | Major Component | | | | | | |
| | | First | Second | Third | | | Fifth | Sixth |
| | | Minor | Minor | Minor | Fourth Minor | | Minor | Minor |
| | Baking | Component | Component | Component | Component | | Component | Component |
| Sample | Temperature | MgCO₃ | SiO₂ | V₂O₅ | Cr₂O₃ | MnO₂ | BaCO₃ | Yb₂O₃ |
| 16 | 1282 | 0.9 | 2.7 | 0.25 | 0.13 | 0.35 | 2 | 1 |
| 17 | 1282 | 0.9 | 2.7 | 0.25 | 0.13 | 0.35 | 2 | 2 |
| 18 | 1282 | 0.9 | 2.7 | 0.25 | 0.13 | 0.35 | 2 | 4.2 |
| 19 | 1282 | 0.9 | 2.7 | 0.25 | 0.13 | 0.35 | 2 | 4.6 |
| 20 | 1282 | 0.9 | 2.7 | 0.25 | 0.13 | 0.35 | 2 | 5 |
| 21 | 1282 | 0.9 | 2.7 | 0.25 | 0.13 | 0.35 | 2 | 5.05 |
| 22 | 1316 | 0.9 | 2.7 | 0.25 | 0.13 | 0.35 | 2 | 4.2 |
| 23 | 1316 | 0.9 | 2.7 | 0.25 | 0.13 | 0.35 | 2 | 5 |
| 24 | 1316 | 0.9 | 2.7 | 0.25 | 0.13 | 0.35 | 2 | 5.05 |

TABLE 7

| | | High Temperature | Determination |
|---|---|---|---|
| Sample | Permittivity | TCC (150° C.) | of Properties |
| 16 | 1417 | −14.6 | ◯ |
| 17 | 1412 | −14.3 | ◯ |
| 18 | 1401 | −14.1 | ◯ |
| 19 | 1381 | −13.9 | ◯ |
| 20 | 1217 | −17.5 | X |
| 21 | 1189 | −18.7 | X |
| 22 | 1189 | −13.8 | ◯ |
| 23 | 1374 | −13.5 | ◯ |
| 24 | 1344 | −13.4 | ◯ |

Samples 16 to 21 of Table 6 represent samples that are baked at a baking temperature of 1282° C. while changing the content of the sixth minor component Yb in a state in which the content of the first minor component Mg is fixed at 0.9 mol, the content of the second minor component Si is fixed at 2.7 mol, the content of the third minor component V is fixed at 0.5 mol, the total content of the fourth minor component (Cr, Mn) is fixed at 0.61 mol and the content of the fifth minor component Ba is fixed at 2 mol, and Samples 22 to 24 represent samples that are baked at a different baking temperature of 1316° C. Samples 16 to 24 of Table 7 represent properties of the samples corresponding to Samples 16 to 24 of Table 6. Meanwhile, Samples 16 to 19, 23 and 24 are the same as Samples 8, 9, 2 and 11 to 13.

When the content of the sixth minor component Yb is less than 10 mol at a baking temperature of lower than 1300° C. (Samples 16 to 19), the high temperature TCC is improved as the content increases, however, when the content of the sixth minor component Yb is 10 mol or greater, the high temperature TCC is weakened instead, failing to satisfy the X8R specification. On the other hand, at a baking temperature of 1300° C. or higher, the high temperature TCC is within ±15% when the content of the sixth minor component Yb is not only less than 10 mol (Sample 22) but also 10 mol or greater (Samples 23 and 24), satisfying the X8R specification. This may suggest that a higher baking temperature is required as the content of the sixth minor component Yb increases. According to embodiments of the present disclosure, it may be said that a baking temperature of 1300° C. or higher is required when the content of the sixth minor component Yb is 10 mol or greater.

The present disclosure is not limited by the above-described embodiments and accompanying drawings, but is limited by the appended claims. Accordingly, it will be obvious to those skilled in the art that various forms of substitutions, modifications and changes are possible within the scope that does not depart from the technical ideas of the present disclosure described in the claims, and these also fall within the technical ideas described in the appended claims.

1. A dielectric composition comprising:
a barium titanate-based base material major component; and
a minor component,
wherein the minor component includes at least one of a first minor component including at least one of oxides and carbonates of fixed-valance acceptor element including Mg; a second minor component including at least one selected from the group consisting of oxides, carbonates and glass of Si element; a third minor component including at least one of oxides and carbonates of V element; a fourth minor component including at least one selected from the group consisting of oxides and carbonates of variable-valence acceptor element including at least one of Mn, Cr, Fe, Ni, Co, Cu and Zn; a fifth minor component including at least one selected from the group consisting of oxides and carbonates of Ba element; and a sixth minor component including at least one selected from the group consisting of oxides and carbonates of Yb element;
the at least one minor component includes the sixth minor component; and
a content of the Yb element included in the sixth minor component is from 0.4 parts by mole to 14 parts by mole with respect to 100 parts by mole of the base material major component.

2. The dielectric composition of claim 1, wherein the at least one minor component further includes the first minor component, and a content of the Mg element included in the first minor component is 2 parts by mole or less with respect to 100 parts by mole of the base material major component.

3. The dielectric composition of claim 1, wherein the at least one minor component further includes the second minor component, and a content of the Si element included in the second minor component is from 0.5 parts by mole to 3.5 parts by mole with respect to 100 parts by mole of the base material major component.

4. The dielectric composition of claim 1, wherein the at least one minor component further includes the third minor component, and a content of the V element included in the third minor component is 3.5 parts by mole or less with respect to 100 parts by mole of the base material major component.

5. The dielectric composition of claim 1, wherein the at least one minor component further includes the fourth minor component, and a total content of the Cr and Mn elements included in the fourth minor component is from 0.2 parts by mole to 4.4 parts by mole with respect to 100 parts by mole of the base material major component.

6. The dielectric composition of claim 5, wherein the content of the Cr element included in the fourth minor component is from 0.1 parts by mole to 4 parts by mole and the content of the Mn element included therein is from 0.1 parts by mole to 0.4 parts by mole, with respect to 100 parts by mole of the base material major component.

7. The dielectric composition of claim 1, wherein the at least one minor component further includes the fifth minor component, and a content of the Ba element included in the fifth minor component is from 0.05 parts by mole to 3 parts by mole with respect to 100 parts by mole of the base material major component.

8. The dielectric composition of claim 1, wherein the content of the Yb element included in the sixth minor component is from 8.4 parts by mole to 10.1 parts by mole with respect to 100 parts by mole of the base material major component.

9. A method for preparing a dielectric composition, the method comprising:
preparing a barium titanate-based base material major component;
preparing at least one minor component including, among a first minor component including at least one of oxides and carbonates of fixed-valance acceptor element including Mg; a second minor component including at least one selected from the group consisting of oxides, carbonates and glass of Si element; a third minor component including at least one of oxides and carbonates of V element; a fourth minor component including at least one selected from the group consisting of oxides and carbonates of variable-valence acceptor element including at least one of Mn, Cr, Fe, Ni, Co, Cu and Zn; a fifth minor component including at least one selected from the group consisting of oxides and carbonates of Ba element; and a sixth minor component including at least one selected from the group consisting of oxides and carbonates of Yb element, the sixth minor component;
preparing a mixture including the base material major component and the at least one minor component; and
baking the mixture,
wherein a content of the Yb element included in the sixth minor component is from 0.4 parts by mole to 14 parts by mole with respect to 100 parts by mole of the base material major component.

10. The method of claim 9, wherein the baking temperature of the mixture is 1250° C. or higher.

11. The method of claim 10, wherein the content of the Yb element included in the sixth minor component is from 8.4 parts by mole to 10.1 parts by mole with respect to 100 parts by mole of the base material major component, and the baking temperature of the mixture is 1300° C. or higher.
